(19) United States
(12) Patent Application Publication
(10) Pub. No.: US 2009/0178058 A1
(43) Pub. Date: Jul. 9, 2009

(54) Application Aware Networking

(75) Inventors: William Charles Stillwell, III, Kirkland, WA (US); Paul Evert Harris, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/971,355

(22) Filed: Jan. 9, 2008

(51) Int. Cl. G06F 3/00

(52) U.S. Cl. 719/317

(57) ABSTRACT

A computer implemented system and method provide for the dynamic bandwidth allocation shift from an end user's committed rate. A service provider receives a request to enhance bandwidth between an end user and a content provider. The service provider queries endpoint information for the end user and identifies the committed rate of the end user. An acceptable enhanced bandwidth shift is determined. The policy manager is signaled to take action to implement the acceptable enhanced bandwidth shift and subsequently shift back to the committed rate. Such a system may include service logic communicating through a content provider signaling interface, a BSS integration interface, and a network equipment provider communicator.

### BACKGROUND

Content providers continually offer end users richer sources of content, such as high-definition video, high-definition audio, large program demo modules, program downloads (including updates), and other content. It is well-known, however, that cutting edge content always exceeds the capacity of the network to deliver it. For example, the time necessary to provide particularly rich content may depend on the size of the content being transferred and the end user's “committed” bandwidth (i.e., the bandwidth allocated consistent with the user's arrangement with the service provider).

Also, in many communications systems, available network resources may be shared among a large number of users. Consequently, a user experience may be tempered by the network resources available for delivery of the content at the time such delivery is requested.

It would be desirable, of course, if additional systems and methods were available to enhance delivery of network-based content. For example, it may be desirable to provide certain content at a certain rate, so that the user doesn't have to wait excessively long to receive the content. It might also be desirable to manipulate other network resources (e.g., QOS, prioritization, routing schemes, etc.) to provide sufficient resources to enhance content delivery. It would particularly desirable if such systems and methods included mechanisms whereby the user could request such enhanced delivery (and, accordingly, pay the service provider for it), or for content providers to request that their content be delivered in a certain manner, regardless of the end-user's arrangement with the service provider (and, accordingly, pay the service provider for it).

### SUMMARY

Disclosed are systems and methods for “application aware networking.” Such systems and methods enable applications to manipulate network elements without knowledge of the specific type of consumer equipment. Examples of such forms of manipulation include direct bandwidth allocation, quality of service (“QOS”), prioritization, and routing schemes. It should be understood that such methodologies may also apply to mobile spectrum usage.

Computer-implemented methods for enhanced delivery of network-based content are provided. Such a method may include receiving a request to deliver content via a network to an end-user device, identifying a network resource that is implicated by the delivery request, manipulating the network resource, and delivering the content through utilization of the manipulated resource. Compensation for the enhanced delivery can be provided to the service provider by the content provider, the end user, advertisers, or a combination thereof.

The service logic to perform such a method may be provided in a “cage” (i.e., on premises) at the service provider. In an example, there may be three interfaces surrounding the logic. First, a signaling interface (e.g., an API) may be provided to enable the content provider to communicate a request for an enhanced network resource (a.k.a., a “boost”). The signaling interface may also indicate, for example, whether the user or content provider is (or should be) paying for the boost. A BSS integration interface may be provided to look up the IP address of the end-user device. Based on the IP address, the BSS interface may determine who the end user is, and whether or not the end user is eligible for the service. A network equipment provider interface may be provided to signal the policy manager to perform certain actions. For example, this interface may signal the policy manager to increase (or decrease) bandwidth, change priority, return to a default state when an action has been completed, etc.

### BRIEF DESCRIPTION OF THE DRAWINGS

FIG. 1 is a high level block diagram of dynamic bandwidth allocation from the end user's committed rate.

FIG. 2 is a high level block diagram of the service provider incorporating the interfaces and logic for dynamic bandwidth allocation from the end user's committed rate.

FIG. 3 is a block diagram showing an example computing environment in which aspects of the invention may be implemented.

### DETAILED DESCRIPTION

Content providers (CP) offer end users (EU) rich/large sources of content, such as high definition video, high definition audio, large program demo module & program down loads (including updates), and other content to mass markets of consumers.

The end user is connected to the content provider by a service provider (SP), such as through an Internet Protocol (IP) network (the Internet) or other communication networks. The committed rate is the bandwidth allocated for the connection between the end user and the content provider. The committed rate is defined by a combination of the committed data rate and the committed burst size. The committed rate is typically determined by the contractual services arranged with the service provider by the end user.

Rich and cutting edge content can easily exceed the capacity of the network to deliver it. The time necessary to provide the rich content is dependent upon the size of the content being transferred and the end user's committed rate. For example, gaming systems such as Xbox Live Marketplace, as well as others, including non-game programs, now offer demos that can typically be as large as 1.2 gigabytes or larger. Even with a typical DSL connection, the download time for this content would be several hours, which is excessive and unacceptable. It is desirable to provide the rich content at an acceptable rate. There is a need to deliver the content at an acceptable rate, by dynamically adjust the allocated bandwidth from the end user's committed rate to an alternate bandwidth rate.

Periodic delivery of large content volume is enabled from delivery points such as a content delivery network (CDN) to an identified/authenticated end user thus providing much lower delivery/download times than before. The CDN may be the place where the content exists and is severed up on behalf of the content provider. The solution may provide for integration with any “content provider” be it a CDN, Flash server, desktop application, etc. The content provider would then be responsible for financial reconciliation with the content owner.

Network operators and content delivery network providers are enabled to identify an end user and dynamically assign more bandwidth capability than provided by the committed rate to drastically lower rich/large content transfer times. In the future, content providers will increasingly offer larger/rich media content to mass markets of end users. This content includes high/standard definition video and program distribution/program updates, which requires a more effective delivery method and system.

Prior to using user presence information to manage the allocation of network resources, network equipment providers and network operators could only allocate resources or reserve bandwidth based on lower level network or application traffic, not by tapping into the end user online presence states. Other types of quality of service networking solutions require that custom applications be deployed on the end user 16 device such as the PC or phone. These solutions while will suited for use in managed environments such as enterprise networks are not feasible for mass markets/consumer offerings.

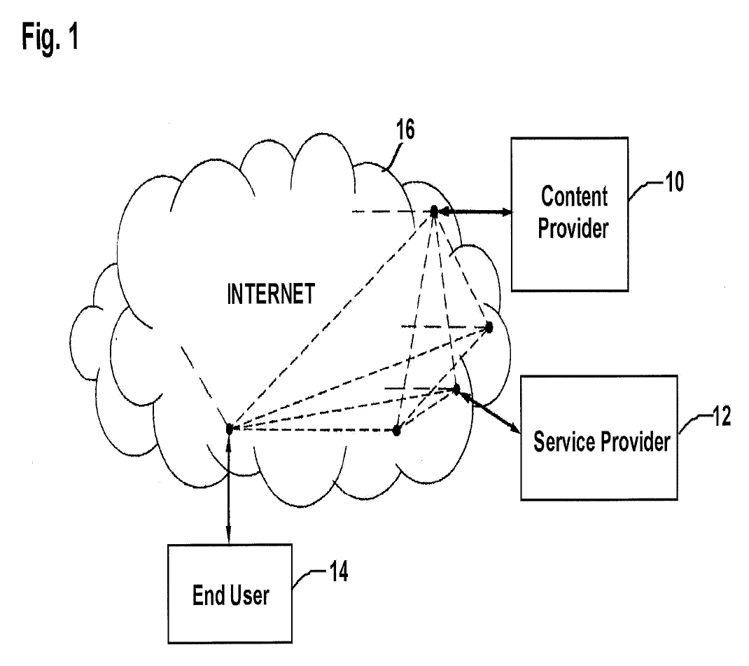

Referring to FIG. 1 there is shown a high level block diagram of dynamic bandwidth allocation from the end user's committed rate. Content provider 12, service provider 14 and end user 16 are shown interconnected through the Internet 18. The large volume content from the content provider 12 is provided to the end user 16. This transfer is controlled by the service provider 14 who identifies the end user 16 and determines the corresponding committed rate. The service provider 14 controls the bandwidth allocated to the transfer, and when the large volume content can not be provided at an acceptable rate, an alternate (enhanced) bandwidth can be temporarily allocated to the end user 16.

The shift from the end user 16 committed rate to an alternate (enhanced) bandwidth can be requested by the content provider 12, the end user 16 or even the service provider 14. When the request is initiated by the content provider 12, the service provider 14 is compensated (paid) for the enhanced bandwidth by the content provider 12. The content provider 12 can provide this request for all users who are attempting to access large volume content, or may provide the requests only for premium end user's 16. A premium end user 16 may pay the content provider 12 a higher subscription/access fee or a one time fee. When the end user 16 provides the request, the service provider can be compensated by the end user 16. In yet a further embodiment, the service provider 14 can initiate the request, which may be linked to alerting the end user 16 of the enhanced bandwidth and used to offer a premium service or upgrade. When the request is initiated by the content provider 12 or the service provider 14 there is no action required by the end user 16. Thus, except for the large volume content being provided at an acceptable rate, the disclosed processes can be transparent to the end user 16. In yet another embodiment, the enhanced bandwidth can be paid for by advertising which is presented to the end user 16.

When the service provider 14 has received a request for an alternate (enhanced) bandwidth from the committed rate of an end user 16, a shift to the alternate bandwidth is made for a predetermined period of time, after which a shift is made back to the committed rate. The content provider 12 can provide the service provider 14 with the size or estimate of the size of the large volume content, which will permit the service provider 14 to estimate how long the shift from the committed rate should be. In another embodiment, the service provider 14 can be notified when the transfer (download) is completed, at which time the shift back to the committed rate can occur. Thus, additional bandwidth from the committed rate is dynamically allocated when the necessity is detected and subsequently scaled back to the committed rate.

Info delivered to service provider 14 includes determining (looking up) in real-time the committed rate of the end user 16 that will receive the large volume content; determine whether enhanced bandwidth provision is desirable. The total expected cost for the enhanced bandwidth for providing the large volume content can be determined and the content provider 12 can determine if the enhanced bandwidth shift from the committed rate should occur or the content provider 12 and the service provider 14 for providing the large volume content can be determined and the content provider 12 can determine if the enhanced bandwidth shift from the committed rate should occur or the content provider 12 and the service provider 14 may negotiate further, including exploring enhanced bandwidth levels either greater or lesser before commitment.

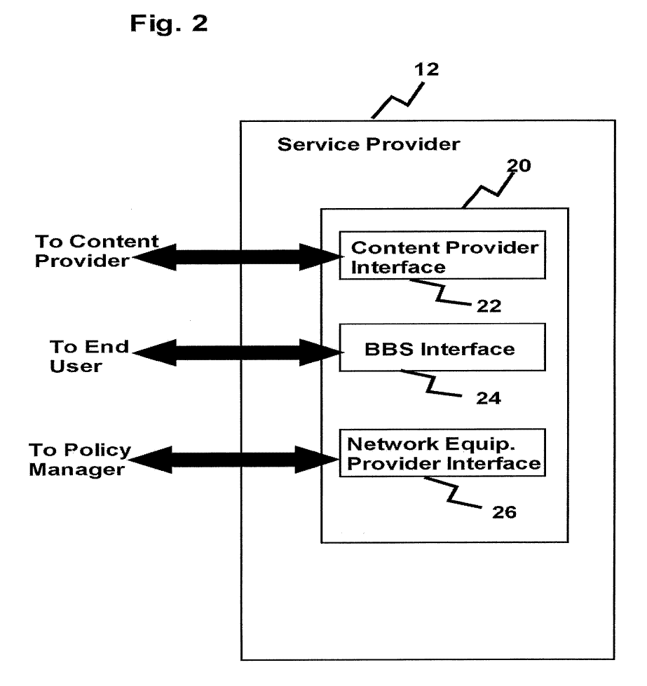

Referring to FIG. 2 there is shown a high level block diagram of the service provider incorporating the dynamic bandwidth allocation from the end user's committed rate. The core of the dynamic bandwidth allocation system is implemented in a system (with the service logic 20 at the service provider 14) which is placed within the network operator premise or is provided as a hosted service that is the central communication point between the content provider 12 and service provider 14.

The service logic 20 provides the necessary logic in cage (on premise) at service provider 14 location. The three interfaces and their surrounding logic are located at the service provider 14 location include: a content provider signaling interface 22 to communicate the request to enhance (boost) the bandwidth from and shift back to the committed rate and identifying who will be paying for the enhanced bandwidth shift; a Basic Set Service (BSS) integration interface 24 to lookup the end user 16 IP address who is who is eligible for the enhanced service; and a network equipment provider communicator 26 which signals the policy manager to go take the necessary action (increase bandwidth, change priority, return to default state when action is over, etc).

In an example, an end user 16 connects to a content provider 12. The end user 16 requests a large volume content (such as a game or application demo file). An event, XML snippet or network signal is sent into the service logic 20 indicating that the end user 16 made a content request of the content provider 12. This can be received through a traffic profile monitoring system or from the online service provider 14. The end user 16 endpoint information is queried from the service logic 20 which determines the presence and identity of the particular end user 16 and the content provider 12. The service logic 20 sends a bandwidth reservation request into the Network Operator systems, raising the aggregate bandwidth for the particular identified end user 16 for the time of the content transfer. The service logic 20 concurrently sends a bandwidth request to the content provider 12 (Content Distributor). Billing events are sent by the service logic 20 into the Content Distribution Network and Network operator systems, who can then offer end users subscription services or pay per use quality of service delivery services.

In another example, a video conferencing desktop application may begin a video conference and send a conference notice to the solution. After receipt of this notification, the solution could do several things. For example, the solution could increase the user's bandwidth, decrease the user's latency, or propose a cost structure to the application for what it will take to get a “boost.” The application could then charge the user, or simply take advantage of the boost that appeared automatically in the background. Meanwhile the solution could have done lookups on the user's account and seen that they have paid for “business boost” where video conferencing is included in their monthly bill.

In a variation of this theme, an application could be presented an array of bandwidth and pricing options, allowing for the user to pick a price and implicitly a networking experience. This price may include a bundled rate from the entire network ecosystem (e.g., the Network Provider, service provider, Application Developer, etc.). For example, a visitor to a video aggregation site may be able to watch a certain low-resolution (say, 320×180) video for free. A high-definition version of the same video may be offered for a nominal charge. Alternatively, the application may include APIs that determine whether the visitor is subscribed to the high-def service through his ISP and, if so, automatically deliver the HD video. The user could have made an impulse purchase for the boosted/shaped network experience.

A cable content provider, such as HBO for example, may want to offer a “premium” package where consumers are able to view movies from the internet. This may not include a boosted experience at all. Instead, the solution may be working in the background to determine a consumer's user service level and enable the download/streaming of this content. In an example of such a scenario, a user may request content from the content provider (e.g., HBO). The content provider may ask its CDN if the user is enabled. The CDN may then call upon the solution, make the determination, and return the result to HBO. This determination may be, for example: a simple “Yes;” deliver the content to the user over their existing bandwidth; or again the chance to boost based on their ISP contract or an impulse buy.

It is well-known that DSL infrastructure is very asymmetric in that the download and upload speeds are typically 5:1. The solution offers the ability for a backup application to make a call and request to have the infrastructure “reversed.” With this completed, the network now allows for the user to receive high bandwidth in an upstream fashion for the duration of something like a first time system backup to the cloud.

Many network-based games require very little bandwidth, and low latency. There are many ways to solve this latency problem, some are very infrastructure specific (DOCSIS, DSL, ATM). The solution, however, offers a simple single point for the game to call and request a low-latency connection to a gaming server or peer. Again the solution could simply perform this task, or run through a set of rules to determine the price, or the user's ISP package to determine whether the service should be free. Ultimately, the game knows nothing of the underlying hardware and simply knows to make a call and get the user a better experience, possibly with a fee.

An application on a mobile phone could make a call to the solution, which may be hosted at the carrier, to request a boost for its content. This allows for things like high speed video to be sent to the handset, while allowing the carrier to not “open the pipe” for all traffic to the handset. By doing this, the carrier can give the premium experience, without giving away unlimited bandwidth on all of its data plans.

### Example Computing Environment

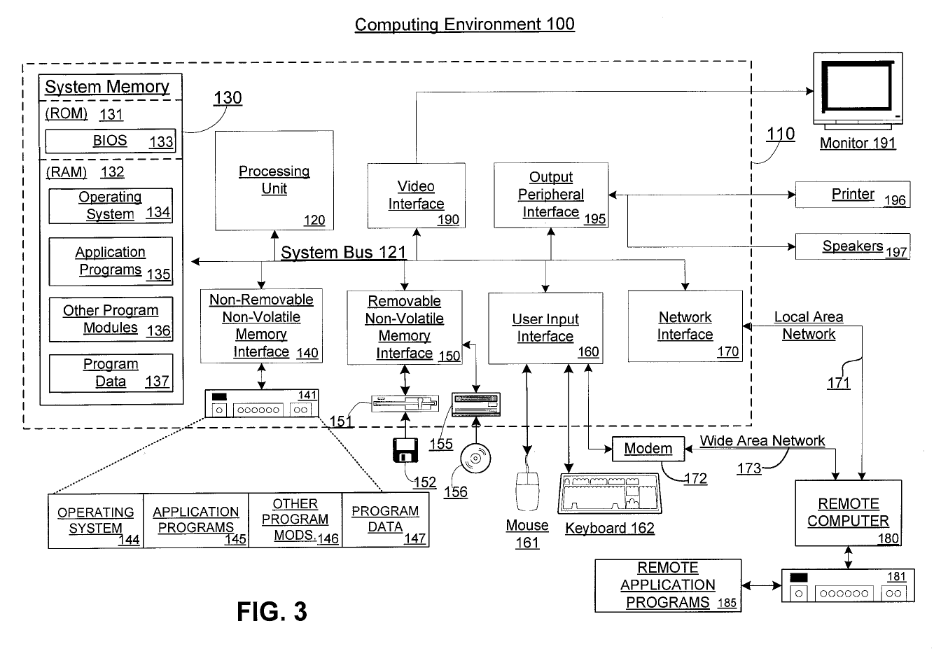

FIG. 3 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 3 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 3, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 3 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 3 provide storage of computer readable instructions, data structures, program modules and other data for the computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 3. The logical connections depicted in FIG. 3 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 3 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

Though the invention has been described in connection with certain preferred embodiments depicted in the various figures, it should be understood that other similar embodiments may be used, and that modifications or additions may be made to the described embodiments for practicing the invention without deviating therefrom. The invention, therefore, should not be limited to any single embodiment, but rather should be construed in breadth and scope in accordance with the following claims.

What is claimed:

1. A computer-implemented method for enhanced delivery of network-based content, the method comprising:
receiving a request to deliver content via a network to an end-user device;
identifying a network resource that is implicated by the delivery request;
manipulating the network resource; and
delivering the content through utilization of the manipulated resource.

2. The method of claim 1, wherein manipulating the network resource comprises increasing a bandwidth available for downloading the content to the end-user device.

3. The method of claim 1, wherein manipulating the network resource comprises changing a priority.

4. The method of claim 1, wherein manipulating the network resource comprises returning the network resource to a default state when an action has been completed.

5. The method of claim 1, further comprising:
determining whether the end user is entitled to receive enhanced delivery based on a relationship between the end user and a service provider.

6. The method of claim 1, further comprising:
determining whether a provider of the content has requested enhanced delivery of the content.

7. The method of claim 1, further comprising:
determining whether a provider of the content has requested enhanced delivery of the content regardless of whether the end user is entitled to receive the enhanced delivery based on a relationship between the end user and a service provider.

8. A computer-implemented system for enhanced delivery of network-based content to an end-user device, the system comprising:
service logic stored on a computer-readable medium;
a signaling interface in communication with the service logic, via which requests for enhanced delivery of the content may be received;
a BSS integration interface in communication with the service logic, via which an identity of the end-user device may be ascertained; and
a network equipment provider interface in communication with the service logic, via which a policy manager may be signaled to manipulate a network resource.

9. The system of claim 8, wherein the signaling interface is an application program interface.

10. The system of claim 8, wherein the signaling interface is adapted to communicate information regarding a payment obligation for the enhanced delivery.

11. The system of claim 8, wherein the BSS integration interface is adapted to determine whether the end user is eligible for the enhanced delivery

12. The system of claim 8, wherein the network equipment provider interface is adapted to signal the policy manager to manipulate a bandwidth available for downloading the content to the end-user device.

13. The system of claim 8, wherein the network equipment provider interface is adapted to signal the policy manager to manipulate a priority.

14. The system of claim 8, wherein the network equipment provider interface is adapted to signal the policy manager to return the network resource to a default state when an action has been completed.

15. A computer-implemented system for enhanced delivery of network-based content to an end-user device, the system comprising:
a receiver for a service provider to receive a request to enhance bandwidth between an end user and a content provider;
a query generator for querying endpoint information for the end user;
an identifier for determining a committed rate of the end user;
a calculator for determining an acceptable enhanced bandwidth shift;
a signaler for signaling policy manager to take action to implement the acceptable enhanced bandwidth shift and shifting back to the committed rate.

16. The system of claim 15, wherein the enhanced bandwidth shift occurs for a predetermined time.

17. The system of claim 15, wherein the enhanced bandwidth shift occurs during a download.

18. The system of claim 15, wherein the request to enhance bandwidth is initiated by the content provider.

19. The system of claim 15, wherein the request to enhance bandwidth is initiated by the end user.

20. The system of claim 15, wherein the enhanced bandwidth is shifted back to a committed bandwidth after a predetermined time.
